(19) United States
(12) Patent Application Publication
(10) Pub. No.: US 2015/0175017 A1
(43) Pub. Date: Jun. 25, 2015

(54) COVER-INTEGRATED CLAMP FOR ELECTRONIC PART IN ECO-FRIENDLY VEHICLE AND METHOD OF MOUNTING THE SAME

(71) Applicant: HYUNDAI MOTOR COMPANY, Seoul (KR)

(72) Inventor: Sang-Chan JEONG, Seoul (KR)

(21) Appl. No.: 14/309,543

(22) Filed: Jun. 19, 2014

(30) Foreign Application Priority Data
Dec. 19, 2013 (KR) 10-2013-0159067

(51) Int. Cl. B60L 11/18; F16B 2/10

(52) U.S. Cl. CPC B60L 11/1809; F16B 2/10

(57) ABSTRACT

A cover-integrated clamp for an electronic part in an eco-friendly vehicle, wherein, in the electronic part of the eco-friendly vehicle in which a component is disposed inside a housing and a cover is fastened to an upper portion of the housing. A clamp elastically supporting the component is installed in a space between the cover and an upper surface of the component. Both ends of the clamp are fitted on one side of the cover, and the upper surface of the component is elastically supported by an intermediate portion of the clamp.

### CROSS-REFERENCE(S) TO RELATED APPLICATIONS

This application claims the benefit of priority to Korean Patent Application No. 10-2013-0159067, filed on Dec. 19, 2013 which is incorporated herein by reference in its entirety.

### TECHNICAL FIELD

The present disclosure relate to a cover-integrated clamp for an electronic part in an eco-friendly vehicle and a method of mounting the same, and more particularly, to a cover-integrated clamp for an electronic part in an eco-friendly vehicle, capable of being fixed to a cover in a state of being elastically supported while elastically supporting a component installed within the electronic part, and a method of mounting the same.

### BACKGROUND

An eco-friendly vehicle such as an electric vehicle (EV), a hybrid electric vehicle (HEV), or a plug-in hybrid electric vehicle (PHEV) is equipped with various electronic parts. The various electronic parts mounted in the eco-friendly vehicle have been developed in order to achieve high power density together with miniaturization thereof.

For instance, the vehicle is equipped with an on-board charger (OBC) used to charge the EV or the PHEV using household electric power, as an example of the electronic parts, and the OBC has been developed in order to achieve the high power density together with the miniaturization thereof.

In order to minimize the electronic parts of the eco-friendly vehicle including the OBC, there is a simple method of reducing the size of the electronic parts themselves or fixing the electronic parts. For example, as shown in FIG. 1 or 2, there is proposed a solution in which an OBC 100 or 100′ fixes a core 112 as a component thereof inside a housing 111 using a clamp 121 or 121′ such that the core 112 is not swung due to vibration transferred from the outside and maintains a constant inductance, thus achieving high power density of the electronic parts.

However, since the above-mentioned clamp 121 or 121′ according to the related art is fastened, at one end thereof, to the housing 111 or the core 112 coupled to the housing 111 while elastically supporting the core 112 at the other end thereof, the housing 111 or a cover 113 coupled to the housing 111 is required to be formed with a mounting boss 131 or 131′ for fastening the clamp 121 or 121′.

That is, referring to FIG. 1, the OBC 100 is configured such that the core 112 is disposed inside the housing 111, the cover 113 is coupled on an upper portion of the housing 111, and the core 112 is pressed against the housing 111 by the clamp 121 within the housing 111. To this end, the mounting boss 131 protrudes upward from the housing 111, and one end of the clamp 121 is fastened to an upper end of the mounting boss 131 by a fastening bolt 132. The clamp 121 is bent such that one end, and the other end thereof have different heights from each other. Accordingly, one end of the clamp 121 is fastened to the mounting boss 131, and the other end thereof comes into contact with an upper surface of the core 112 to support the core 112.

As another example of the related art, as shown in FIG. 2, the mounting boss 131′ protrudes downward from the cover 113 toward the housing 111. Consequently, one end of the clamp 121′ is fastened to a lower end of the mounting boss 131′ by a fastening bolt 132, and the other end thereof comes into contact with an upper surface of the core 112 so as to support the core 112.

However, as shown in FIG. 1 or 2, since the mounting boss 131 or 131′ is separately formed in the housing 111 or the cover 113 for fastening the clamp 121 or 121′, an installation space of the mounting boss 131 or 131′ is further required inside the electronic part, such as the OBC 100 or 100′, thereby preventing from reducing the number of the electronic parts.

In addition, since a separate tool is used to fasten one end of the clamp 121 or 121′ to the mounting boss 131 or 131′ using the fastening bolt 132, an assembly process thereof may be inconvenient.

Furthermore, since only one end of the clamp 121 or 121′ is fastened to the mounting boss 131 or 131′, and the other end thereof is centered on the core 112, a process of fastening the clamp 121 or 121′ may be inconvenient.

### SUMMARY

An embodiment of the present disclosure is directed to a cover-integrated clamp for an electronic part in an eco-friendly vehicle, capable of elastically supporting a component inside an electronic part of the eco-friendly vehicle only by fitting the clamp on a cover without a separate fastening means, and a method of mounting the same.

Another embodiment of the present disclosure is directed to a cover-integrated clamp for an electronic part in an eco-friendly vehicle, capable of minimizing the size of the electronic part of the eco-friendly vehicle by directly fastening the clamp to a cover inside the electronic part so that an installation space of a mounting boss for fastening the clamp is unnecessary, and a method of mounting the same.

Other objects and advantages of the present disclosure can be understood by the following description and become apparent with reference to the embodiments of the present disclosure. Also, it is obvious to those skilled in the art to which the present disclosure pertains that the objects and advantages of the present disclosure can be realized by the means as claimed and combinations thereof.

In accordance with an embodiment of the present disclosure, a cover-integrated clamp for an electronic part in an eco-friendly vehicle is provided. In the electronic part of the eco-friendly vehicle in which a component is installed inside a housing, and a cover is fastened to an upper portion of the housing, the clamp elastically supporting the component is installed in a space between the cover and an upper surface of the component, both ends of the clamp are fitted on one side of the cover, and the upper surface of the component is elastically supported by an intermediate portion of the clamp.

The cover may have mounting protrusions which protrude downward from a lower surface of the cover and are spaced apart from each other. The both ends of the clamp may be respectively fitted to the mounting protrusions so that the clamp is installed to the mounting protrusions.

The both ends of the clamp may be respectively formed with coupling portions such that the coupling portions are bent so as to be located over a main body of the clamp and are fitted to the mounting protrusions.

The mounting protrusions may be formed with fitting grooves into which the ends of the clamp are fitted, and the coupling portions of the clamp may be formed with coupling grooves such that the coupling grooves are fitted into the fitting grooves to grasp the fitting grooves.

The intermediate portion of the clamp may be formed with elastic support portions which extend from the main body and ends of which come into contact with the upper surface of the component, so that the clamp is elastically supported between the cover and the upper surface of the component.

The elastic support portions may extend from the main body so as to face each other.

The electronic part may be an on-board charger (OBC) of the eco-friendly vehicle.

The component may be a core installed within the OBC.

In accordance with another embodiment of the present disclosure, a method of mounting a clamp includes coupling portions extending outward from a main body and elastic support portions extending from the main body toward a center thereof and inclined downward, inside an electronic part of an eco-friendly vehicle. Clamp side pressing is performed in which both sides of the clamp are pressed to retract the clamp, clamp fixing is performed in which both ends of the retracted clamp is located in fitting grooves formed on a cover and external force pressed on the sides of the clamp is removed so that the clamp is fixed to the cover, component mounting is performed in which a component for the electronic part of the eco-friendly vehicle is mounted inside a housing, and cover fastening is performed in which the cover equipped with the clamp is located on an upper portion of the housing equipped with the component and the cover is fastened to the housing in a state of elastically supporting an upper surface of the component by the clamp.

The step of performing the component mounting may be carried out prior to the step of performing the clamp side pressing, instead of being carried out after the performing clamp fixing.

### BRIEF DESCRIPTION OF THE DRAWINGS

FIG. 1 is a cross-sectional view illustrating a stat in which a core is supported by a clamp according to the related art in an on-board charger (OBC) of an eco-friendly vehicle to which the clamp is applied.

FIG. 2 is a cross-sectional view illustrating a state in which a core is supported by a clamp in an OBC of an eco-friendly vehicle according to another example of the relater art.

FIG. 3 is a cross-sectional view illustrating an OBC of an eco-friendly vehicle to which a cover-integrated clamp for an electronic part in an eco-friendly vehicle according to the present disclosure is applied.

FIG. 4 is a cross-sectional view illustrating a decoupled state of a housing, a cover, and a clamp in an OBC of an eco-friendly vehicle to which a cover-integrated clamp for an electronic part in an eco-friendly vehicle according to the present disclosure is applied.

FIG. 5 is a perspective view illustrating a coupling relation between a cover-integrated clamp for an electronic part in an eco-friendly vehicle according to the present disclosure and the cover.

FIG. 6 is a flowchart illustrating a method of mounting a clamp according to the present disclosure.

### DETAILED DESCRIPTION

A cover-integrated clamp for an electronic part in an eco-friendly vehicle according to exemplary embodiments of the present disclosure will be described below in more detail with reference to the accompanying drawings. The present disclosure may, however, be embodied in different forms and should not be construed as limited to the embodiments set forth herein. Rather, these embodiments are provided so that this disclosure will be thorough and complete, and will fully convey the scope of the present disclosure to those skilled in the art. Throughout the disclosure, like reference numerals refer to like parts throughout the various figures and embodiments of the present disclosure.

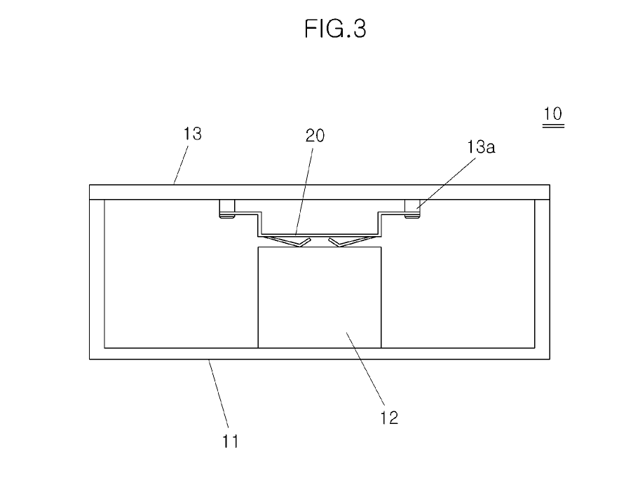

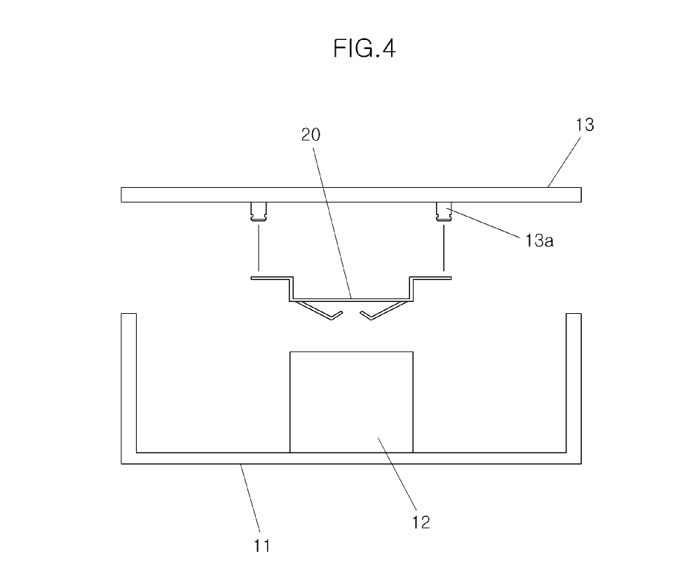

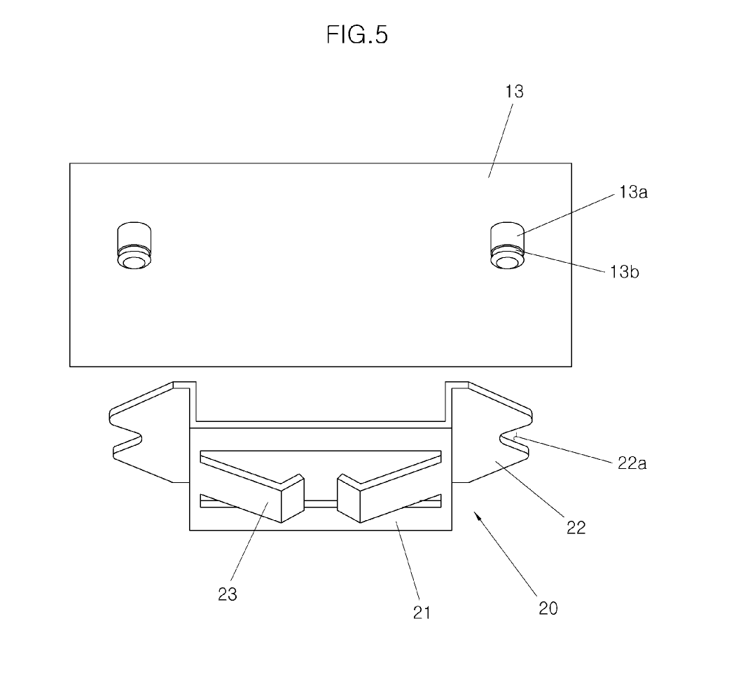

Referring to FIGS. 3 to 5, in a cover-integrated clamp for an electronic part in an eco-friendly vehicle according to the present disclosure, mounting protrusions 13a are formed on a lower surface of a cover 13 coupled on an upper portion of a housing 11 installed with components, and a clamp 20 is installed to the cover 13 by being fitted to the mounting protrusions 13a.

Hereinafter, in an OBC 10 as an example of an electronic part in the eco-friendly vehicle, a description will be given of an example in which the clamp 20 elastically supports a core 12 as a component of the OBC 10.

The clamp 20 is disposed in a space between the cover 13 of the OBC 10 as the electronic part in the eco-friendly vehicle and the core 12 as the component of the OBC 10. The clamp 20 elastically supports a gap between the cover 13 and the core 12 so that the core 12 may be pressed against the housing 11. To this end, the clamp 20 includes a main body 21, couplers 22 which extend outward from both ends of the main body 21, and elastic supporters 23 which extend from inside the main body 21. The lower surface of the cover 13 has the mounting protrusions 13a which protrude downward from the cover 13 and are spaced apart from each other, such that the clamp 20 is fitted to the mounting protrusions 13a. The mounting protrusions 13a have fitting grooves 13b into which both ends of the clamp 20 are fitted. The main body 21 defines an intermediate portion of the clamp 20, and the couplers 22 and the elastic supporters 23 extend from the main body 21.

The couplers 22 extend outward from the both ends of the main body 21. The couplers 22 define the both ends of the clamp 20 and are portions fitted to the mounting protrusions 13a. The couplers 22 are preferably bent so as to be located over the main body 21 since a space is defined between the cover 13 and an upper surface of the core 12. In addition, in order to reinforce coupling force when the couplers 22 are fitted to the mounting protrusions 13a, the couplers 22 have coupling grooves 22a, such that the couplers 22 are easily coupled into the fitting grooves 13b and the resultant state is maintained. Accordingly, when the couplers 22 are fitted into the fitting grooves 13b of the mounting grooves 13a, the couplers 22 grasp the mounting protrusions 13a by the coupling grooves 22a, thereby reinforcing the coupling force between the clamp 20 and the mounting protrusions 13a.

The elastic supporters 23 extend from the main body 21. The elastic supporters 23 extend from the outside of the main body 21 toward the center thereof, and one end of each of the elastic supporters 23, which is connected to the main body 21, is inclined toward the other end of the elastic supporter 23. The elastic supporters 23 face each other from both outsides of the main body 21 toward the center thereof. Accordingly, the other ends of the elastic supporters 23 come into contact with the upper surface of the core 12 so that the clamp 20 elastically supports the core 12.

As shown in FIGS. 3 to 5, the clamp 20 has a structure in which both left and right sides thereof are symmetrical to each other on the basis of the center thereof. That is, the couplers 22 are respectively formed at the both sides of the main body 21, and the elastic supporters 23 are formed on the main body 21 so as to face each other, thereby allowing the clamp 20 to have a symmetrical structure.

The clamp 20 having the above-mentioned configuration is mounted to the cover 13, and then the cover 13 is fastened to the housing 11 so that the clamp 20 elastically supports a gap between the cover 13 and the housing 11 inside the electronic part. The cover 13 is turned over, and the lower surface of the cover 13 is disposed to be directed upward such that the clamp 20 may be easily mounted to the cover 13.

In a state of turning-over the cover 13, the clamp 20 is slightly retracted such that the couplers 22 of the clamp 20 are fitted into the fitting grooves 13b of the mounting protrusions 13a, and thus, installation thereof is simply completed. When the couplers 22 of the clamp 20 are fitted into the fitting grooves 13b of the mounting protrusions 13a, the coupling grooves 22a of the couplers 22 grasp the mounting protrusions 13a at electronic parts formed with the coupling grooves 22a, thereby improving the coupling force between the clamp 20 and the cover 13.

In a state in which the clamp 20 is coupled on the cover 13, the cover 13 is again turned over and is then fastened to the upper portion of the housing 11. When the cover 13 coupled to the clamp 20 is fastened to the housing 11, the clamp 20 pushes the core 12 of the OBC 10, such that the core 12 is not swung due to vibration transferred from the outside, thereby pressing the core 12 d against the housing 11. Accordingly, the core 12 may exhibit a desired function in the OBC 10.

Although the present embodiment has been illustratively described with respect to a case in which the electronic part is the OBC 10 of the eco-friendly vehicle, and the component is the core 12 of the OBC 10, the present disclosure is not limited thereto. For example, the present disclosure may be applied to all cases in which, in order to elastically support the component equipped in the electronic part of the eco-friendly vehicle, the cover is fastened to the housing of the electronic part by fitting the clamp 20 to the cover of the electronic part.

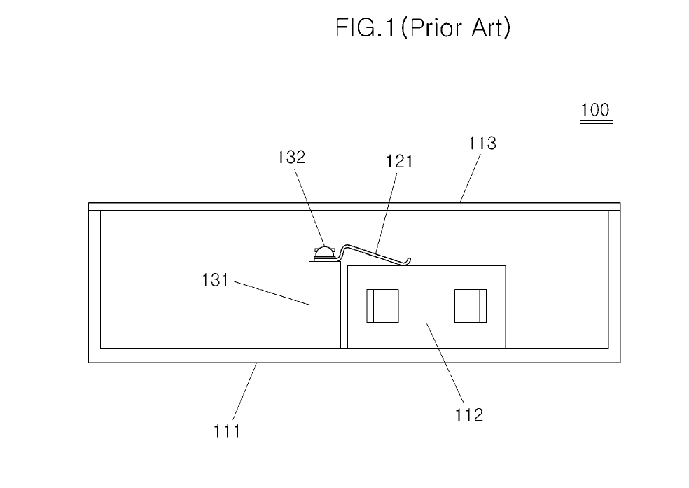

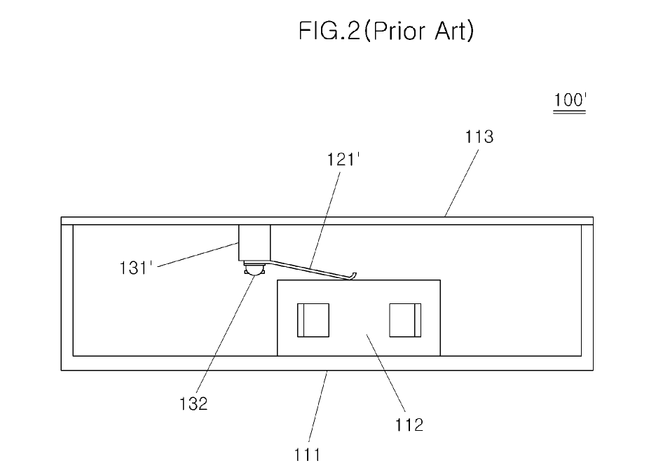

Thus, the clamp 20 is disposed in a space between the component, and the cover in the electronic part of the eco-friendly vehicle and is fitted on the cover so as to elastically support the component within the electronic part, thereby enabling the component to sufficiently exhibit a function in the electronic part. In addition, since an additional space for installing the clamp 20, for instance, an installation space of the mounting boss in FIG. 1 or 2 is unnecessary, the size of the electronic part may be minimized Moreover, when the both ends of the clamp 20 are coupled on the cover 13, the intermediate portion of the clamp 20 elastically support the central portion of the upper surface of the component. Therefore, the component may be stably supported inside the electronic part.

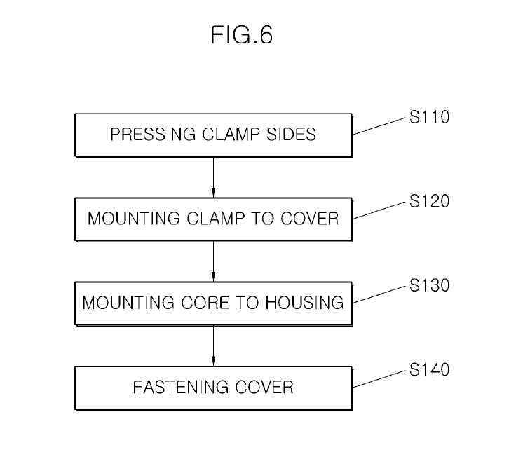

Hereinafter, a description will be given of a method of mounting the clamp according to the present disclosure with reference to FIG. 6. The method of mounting the clamp according to the present disclosure is a method of mounting the above-mentioned cover-integrated clamp for an eco-friendly vehicle inside the eco-friendly vehicle.

The method includes a clamp side pressing step S110 of pressing both sides of the clamp 20 to retract the clamp 20, and a clamp fixing step S120 of locating both ends of the clamp 20, which is retracted, in the fitting grooves 13b and removing external force pressed on the sides of the clamp 20 so that the clamp 20 is fixed to the cover 13. A component mounting step S130 mounts a component for the electronic part of the eco-friendly vehicle inside the housing 11, and a cover fastening step S140 locates the cover 13 equipped with the clamp 20 on the upper portion of the housing 11 equipped with the component and fastening the cover 13 to the housing 11 in a state in which the clamp 20 elastically supports the upper surface of the component.

In the clamp side pressing step S110, the both ends of the clamp 20 are pressed and the clamp 20 is retracted. The clamp 20 is not fitted to the mounting protrusions 13a formed on the cover 13 when removing the external force. Therefore, by pressing and retracting the clamp 20 such that a width thereof is narrowed, the clamp 20 may be fitted to the mounting protrusions 13a.

The clamp fixing step S120 is performed such that the retracted clamp 20 is fixed to the mounting protrusions 13a formed on the lower surface of the cover 13. After the coupling portions 22 of the retracted clamp 20 are located to the mounting protrusions 13a of the cover 13, the clamp 20 is fixed to the mounting protrusions 13a by removing external force exerted to retract the clamp 20, thereby fixing the clamp 20 to the cover 13.

The component mounting step S130 is performed such that the component for the electronic part is mounted inside the housing 11 defining the external appearance of the electronic part in the eco-friendly vehicle. For example, the core 12 may be mounted inside the housing 11 of the OBC.

The cover fastening step S140 is a process of fastening the cover 13 to the housing 11. In a state in which the component such as the core 12 is inside the housing 11, the fixed cover 13 is fastened to the clamp 20 in the housing 11. In this case, the cover 13 is fastened to the housing 11 in a state in which the clamp 20 elastically supports the central portion of the upper surface of the component, and thus, the clamp 20 elastically supports the component such as the core 12 between the cover 13 and the housing 11.

The component mounting step S130 may be performed prior to the clamp side pressing step S110. That is, the method may also be performed in order of the component mounting step S130, the clamp side pressing step S110, the clamp fixing step S120, and the cover fastening step S140.

In accordance with a cover-integrated clamp for an electronic part in an eco-friendly vehicle and a method of mounting the same according to exemplary embodiments of the present disclosure, since an installation space of a mounting boss for fastening a clamp is unnecessary, an electronic part in an eco-friendly vehicle may be minimized to the extent of the installation space of the mounting boss.

In addition, since the clamp is installed only by being fitted on a cover, and thus a fastening bolt is unnecessary for mounting the clamp to the cover, a process of fastening the fastening bolt using a tool is not required. Accordingly, the clamp may be stably installed to the cover only by fitting both ends of the clamp to mounting protrusions protruding from the cover.

Moreover, since the cover-integrated clamp has a structure in which the both ends of the clamp are fixed to the cover, and an intermediate portion thereof comes into contact with an upper surface of a core, the clamp may support a center of the core only by installing the clamp to the cover without adjusting a position of the clamp such that the clamp supports the center of the core.

While the present disclosure has been described with respect to the specific embodiments, it will be apparent to those skilled in the art that various changes and modifications may be made without departing from the spirit and scope of the disclosure as defined in the following claims.

What is claimed is:

1. A cover-integrated clamp for an electronic part in an eco-friendly vehicle,
wherein the electronic part of an eco-friendly vehicle includes a component disposed inside a housing, and a cover fastened to an upper portion of the housing,
wherein the cover-integrated clamp includes a clamp elastically supporting the component installed in a space between the cover and an upper surface of the component, both ends of the clamp being fitted on one side of the cover, and the upper surface of the component being elastically supported by an intermediate portion of the clamp.

2. The cover-integrated clamp of claim 1, wherein
the cover has mounting protrusions which protrude downward from a lower surface of the cover and are spaced apart from each other, and
the both ends of the clamp are respectively fitted to the mounting protrusions so that the clamp is mounted to the mounting protrusions.

3. The cover-integrated clamp of claim 2, wherein the both ends of the clamp respectively have couplers such that the couplers are bent so as to be disposed over a main body of the clamp and are fitted to the mounting protrusions.

4. The cover-integrated clamp of claim 3, wherein
the mounting protrusions have fitting grooves into which the ends of the clamp are fitted; and
the couplers of the clamp have coupling grooves such that the coupling grooves are fitted into the fitting grooves to grasp the fitting grooves.

5. The cover-integrated clamp of claim 3, wherein the intermediate portion of the clamp has elastic supporters which extend from the main body and ends of which come into contact with the upper surface of the component, so that the clamp is elastically supported between the cover and the upper surface of the component.

6. The cover-integrated clamp of claim 5, wherein the elastic supporters extend from the main body so as to face each other.

7. The cover-integrated clamp of claim 1, wherein the electronic part is an on-board charger (OBC) of the eco-friendly vehicle.

8. The cover-integrated clamp of claim 7, wherein the component is a core installed within the OBC.

9. A method of mounting a clamp, which includes couplers extending outward from a main body and elastic supporters extending from the main body toward a center thereof and inclined downward, inside an electronic part of an eco-friendly vehicle, the method comprising steps of:
performing clamp side pressing in which both sides of the clamp are pressed to retract the clamp;
performing clamp fixing in which both ends of the retracted clamp is disposed in fitting grooves formed on a cover and external force pressed on the both sides of the clamp is removed so that the clamp is fixed to the cover;
performing component mounting in which a component for the electronic part of the eco-friendly vehicle is mounted inside a housing; and
performing cover fastening in which the cover having the clamp is disposed on an upper portion of the housing having the component and the cover is fastened to the housing in a state of elastically supporting an upper surface of the component by the clamp.

10. The method of claim 9, wherein the step of performing component mounting is carried out prior to the step of performing clamp side pressing, instead of being carried out after the step of performing clamp fixing.
